(19) United States
(12) Patent Application Publication
(10) Pub. No.: US 2009/0115575 A1
(43) Pub. Date: May 7, 2009

(54) Apparatus, system for storing data, and method for accessing data directory

(76) Inventors: Shao-Ming Lee, Tsao Tuen (TW); Chuan-Lien Yang, Tsao Tuen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,284

(22) Filed: Nov. 1, 2007

(51) Int. Cl. H04Q 5/22

(52) U.S. Cl. 340/10.1

(57) ABSTRACT

A storage apparatus includes a memory unit, a tag and a controller, wherein the tag is used to store a data directory and the controller is used to control the data access of the memory unit. Moreover, a storage system includes the storage apparatus and a host computer, wherein the host computer connects to the memory unit, the tag and the controller so that the host computer commands the controller to control the data access between the memory unit and host computer. Furthermore, the host computer updates the data directory of the tag in response to the updated data of the memory unit.

### BACKGROUND OF THE INVENTION

1. Field of the Invention

The present invention relates to a data storage apparatus, a data storage system and a data directory accessing method, and more particularly to a data storage apparatus having an electronic tag, and a system and a method for updating a data directory of the data storage apparatus when the data storage apparatus is connected, and read the data directory of the data storage apparatus when the data storage apparatus is disconnected.

2. Description of Related Art

As digital information and high-resolution digital audio/video advance rapidly, the demand for a huge data storage becomes increasingly higher. Although the present DVD, HD DVD or Blue-ray DVD can satisfy consumer requirements, yet a large number of DVD disks causes a problem of classifying and managing digital data. Therefore, a high-capacity data storage apparatus (such as a hard disk) becomes an indispensable storage equipment.

Referring to FIG. 1 for a schematic view of a host computer and a data storage apparatus according to a prior art, the data storage apparatus such as a hard disk 2 comes with a large capacity and a low cost, but the major problem resides on that the hard disk 2 is always situated at a power consuming status, regardless of the host computer 1 accessing data or not. If the host computer 1 stops accessing data from the hard disk 2, the prior art will cause a waste of electric power and reduce the life expectancy of the hard disk 2. To avoid wasting electric power when the hard disk 2 is idle, users may set the hard disk 2 and the host computer 1 to a disconnected status to save electric power. However, the host computer 1 cannot determine the type of digital data stored in the hard disk 2 when it is disconnected. If the number of disconnected hard disks 2 is large, users will have troubles of searching digital data.

### SUMMARY OF THE INVENTION

In view of the foregoing shortcoming of the prior art, it is a primary objective of the present invention to install an electronic tag (such as RFID) in a data storage apparatus that operates with a software control of a host computer to store a directory of the data storage apparatus connected to the host computer into the electronic tag. If the data storage apparatus and the host computer are disconnected, an administrator of the host computer can know about the number of disconnected data storage apparatuses and their label IDs through a wireless method, so that the file directory of data files of the data storage apparatus can be learned quickly from the electronic tag of the data storage apparatus to facilitate an offline management of huge data and achieve the power saving effect.

To achieve the foregoing objective, the present invention provides a data storage apparatus, and the data storage apparatus comprises a memory unit for storing a data content; an electronic tag for storing a data directory; and a controller connected to the memory unit, for controlling the data content in the memory unit.

With the application of the foregoing data storage apparatus, the present invention provides a data storage system, and the data storage system comprises: a memory unit for storing a data content; an electronic tag for storing a data directory; a host computer connected to the memory unit and the electronic tag; and a controller connected to the memory unit and the host computer. The controller controls the memory unit and the host computer to access data according to a command of the host computer. The host computer installs a directory management software and a database and comes with the capability of transmitting, receiving, and reading the electronic tag via a wireless transmission. Therefore, the host computer can update the data directory in an electronic tag according to an updated data content in the memory unit.

In summation of the description above, the present invention provides a directory accessing method of the data storage apparatus, and the method comprises the steps of: providing a data storage apparatus having an electronic tag, wherein the electronic tag stores a data directory of the data storage apparatus; determining whether or not the data storage apparatus and the host computer are connected; if yes, then the host computer will read a data directory of the data storage apparatus; the host computer executing the directory management software to determine whether or not the read data directory matches with the data of the data storage apparatus; and writing an updated data directory into the electronic tag to complete updating the data directory, if the data directory does not match.

With the description above, the present invention provides a data storage apparatus that operates with a host computer, wherein a directory management software installed in the host computer allows the host computer to synchronously update a data in the data storage apparatus and a data directory in the electronic tag. If the data storage apparatus is disconnected, the host computer can read a data directory stored in the electronic tag of the data storage apparatus for searching the data directory to know about the location of the required file, so as to effectively manage a large number of disconnected data storage apparatuses, while reducing unnecessary operation and power consumption of the data storage apparatus.

To make it easier for our examiner to understand the innovative features and technical content, we use preferred embodiments together with the attached drawings for the detailed description of the invention, but it should be pointed out that the attached drawings are provided for reference and description but not for limiting the present invention.

### BRIEF DESCRIPTION OF THE DRAWINGS

FIG. 1 is a schematic view of a host computer and a data storage apparatus according to a prior art;

FIG. 2 is a functional block diagram of a data storage apparatus of the present invention;

FIG. 3 is a functional block diagram of a data storage system of the present invention; and

FIG. 4 is a flow chart of a data directory accessing method of the present invention.

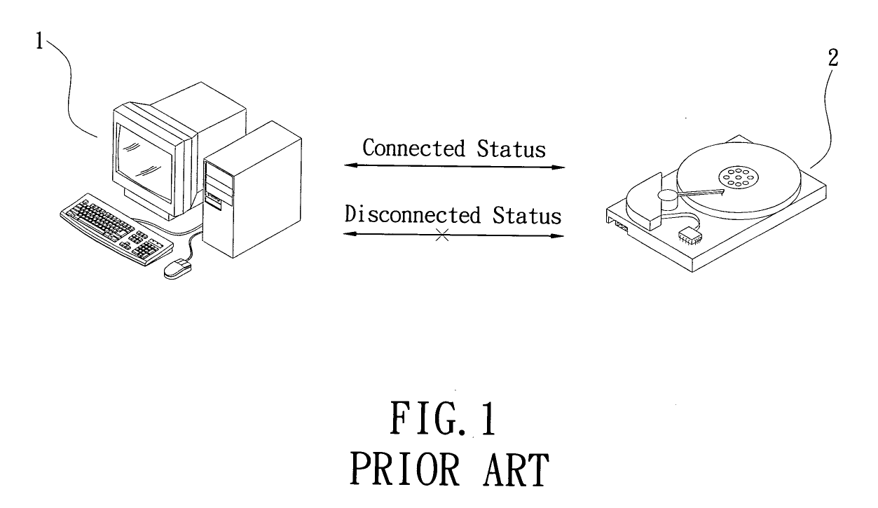

### DETAILED DESCRIPTION OF THE PREFERRED EMBODIMENTS

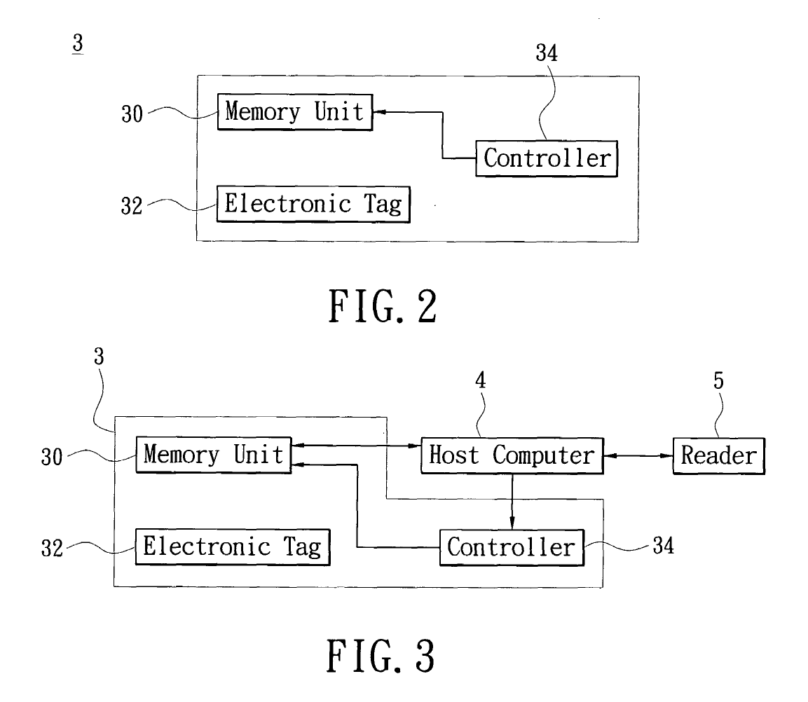

Referring to FIG. 2 for a functional block diagram of a data storage apparatus of the present invention, the data storage apparatus 3 comprises a memory unit 30, an electronic tag 32 and a controller 34. The memory unit 30 stores a digital data content, and the electronic tag 32 stores a label ID of the data storage apparatus 3 and a data directory of the data content in the memory unit 30. In the meantime, the controller 34 is connected to the memory unit 30 for controlling an access of data content in the memory unit 30. The data storage apparatus 3 is a general hard disk or flask disk with an electronic tag 32 and the electronic tag 32 is provided for storing a data directory of the hard disk or flash disk, and the electronic tag 32 will update a corresponding stored data directory according to the data updates of the hard disk or the flash disk.

Referring to FIG. 3 for a functional block diagram of a data storage system of the present invention, the data storage system comprises a memory unit 30, an electronic tag 32, a controller 34 and a host computer 4. The memory unit 30, the electronic tag 32 and the controller 34 constitute the aforementioned data storage apparatus 3 of the invention, and thus will not be described further here. The host computer 4 is connected to a memory unit 30 and a controller 34 in the data storage apparatus 3. The host computer 4 commands the controller 34 to transmit data between the memory unit 30 and the host computer 4. If the host computer 4 and the data storage apparatus 3 are connected, the host computer 4 can execute a directory management software to write a data directory corresponding to the data content in the memory unit 30 into the electronic tag 32. To enhance the security of data transmissions, the host computer 4 needs to obtain a label ID authentication for accessing the electronic tag 32 before updating the data directory in the electronic tag 32.

In FIG. 3, the electronic tag 32 can be in the form of an active RFID tag or a smart tag. Therefore, the host computer 4 can update or read a data directory in the electronic tag 32 by a wireless transmission method, and the host computer 4 has to be connected to a reader 5, so that the reader 5 can be controlled to read the data directory in the electronic tag 32. If the data storage apparatus 3 and the host computer 4 are disconnected, the host computer 4 will execute a directory management software to obtain the quantity of disconnected data storage apparatuses 3 and their label IDs, and learn about the data directory of the data storage apparatus 3 quickly according to the data file on the electronic tag 32 of the data storage apparatus 3 to facilitate an offline management of a large quantity of data, and also achieve the power saving effect.

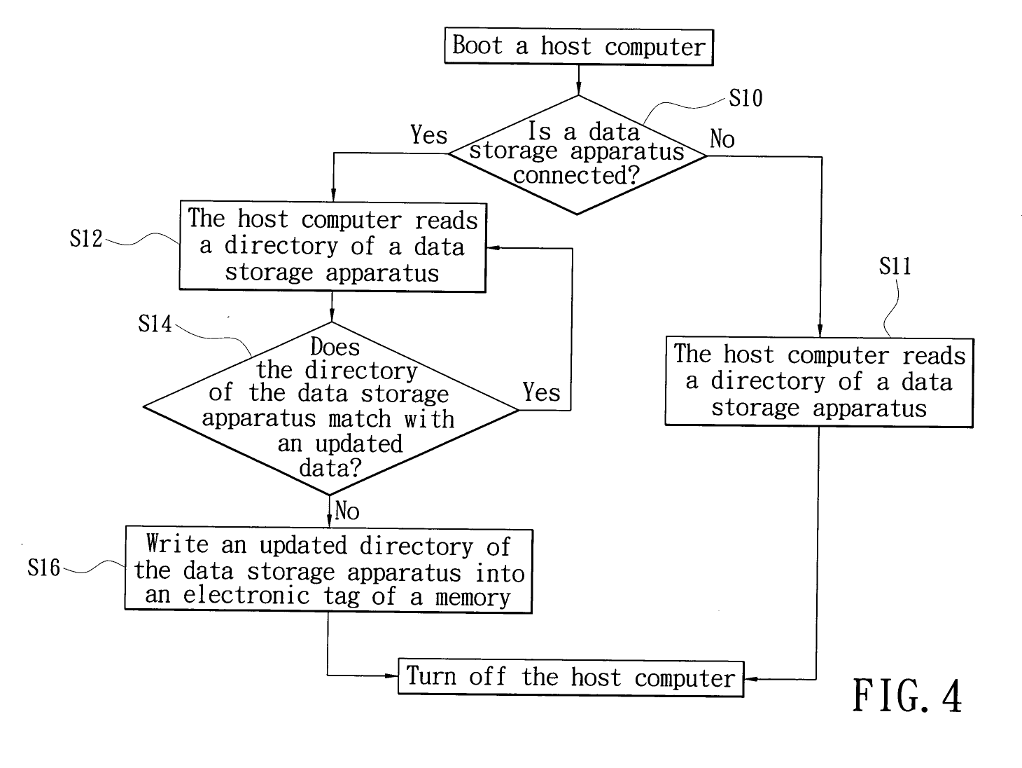

Refer to FIG. 3 as well as FIG. 4 for a flow chart of a directory accessing method of the present invention, the method comprises the steps of: providing a data storage apparatus 3 having an electronic tag 32 and electrically connected to a host computer 4, wherein the electronic tag 32 stores a data directory of the data storage apparatus 3; and then the host computer 4 determining whether or not the data storage apparatus 3 is situated at a connected status (S10).

If the data storage apparatus 3 and the host computer 4 are disconnected, the host computer 4 will read or write a data content into the data storage apparatus 3 and obtain a data directory of data storage apparatus 3 from the electronic tag 32 (S12). Then, the host computer 4 executes a directory management software to determine whether or not the read data directory matches with the data content in the data storage apparatus 3 (S14). For an unmatched data in the foregoing determination, the host computer 4 executes a directory management software to write a data directory matched with the data content of the data storage apparatus 3 into the electronic tag 32 for updating the data directory in the electronic tag 32 (S16).

In FIGS. 3 and 4, if the determination after the Step (S10) is determined to be a disconnected status, the host computer 4 will read a data directory stored in an electronic tag 32 of the data storage apparatus 3 by a wireless or cable method (S11) and search the data directory learn about the location of the required file, so as to effectively manage a large number of disconnected data storage apparatuses 3, and also reduce unnecessary operation and power consumption of the data storage apparatus 3.

In FIGS. 3 and 4, the host computer 4 in the foregoing Step (S12) needs to obtain an access authentication (which is a label ID authentication) for accessing the electronic tag 32 before the host computer 4 can read or write a data content into the data storage apparatus 3 and obtain the data directory of the data storage apparatus 3 from the electronic tag 32. In the aforementioned label ID authentication procedure, the host computer 4 needs to load a serial number represented by the electronic tag 32 into the directory management software and execute the directory management software, so that the host computer 4 can access a data storage apparatus 3 of the specified serial number, and update the data directory of the specified data storage apparatus 3.

Further, the host computer 4 in the Step (S11) needs to obtain an access authentication (which is a label ID authentication) for accessing the electronic tag 32 before the host computer 4 can obtain a data directory of the data storage apparatus 3 from the electronic tag 32. The label ID authentication procedure is the same as the Step (S12), and thus will not be described here. After the Step (S14) is determined, the procedure returns to the Step (S12) if the determination is affirmative, and the host computer 4 will continue reading or writing a data content into the data storage apparatus 3 and obtain the data directory of the data storage apparatus 3 from the electronic tag 32.

In summation of the description above, the data storage apparatus 3 of the present invention operates with the host computer 4, wherein the directory management software installed in the host computer 4 allows the host computer 4 to synchronously update the data in the data storage apparatus 3 to update the data directory of the electronic tag. If the data storage apparatus 3 is disconnected, the host computer 4 can read the data directory stored in an electronic tag of the data storage apparatus 3 by a wireless method to effectively manage a large number of disconnected data storage apparatuses and also reduce unnecessary operation and power consumption of the data storage apparatus.

As described above, a user can operate the host computer 4 to read the data directory of the data storage apparatus 3 stored in the electronic tag at a disconnected status via a wireless method, and search for a data directory to learn about the location of a required file. If the user knows the location of the required file, the user can operate the host computer 4 to wake up the data storage apparatus 3 at a disconnected status, allow the data storage apparatus 3 to resume its connection with the host computer 4, and receive power supply again. Therefore, the data storage apparatus 3 of the invention can provide an internal data directory to the host computer 4 at a disconnected status, and thus such application can save unnecessary operation and power consumption.

In addition to the electronic tag, the invention can also use a flash memory to substitute the electronic tag, and install the flash memory in the data storage apparatus. Similarly, users can operate and control a software in the host computer to store a directory of the data storage apparatus connected to the host computer into the flash memory. If the data storage apparatus and the host computer are disconnected, an administrator of the host computer can learn about the number of the disconnected data storage apparatuses via a cable method and quickly know the file directory of the data storage apparatus from the data file in the flash memory of the data storage apparatus to facilitate an offline management of a large quantity of data and also achieve the power saving effect.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A data storage apparatus, for storing a data content, characterized in that:
the data storage apparatus comprises an electronic tag for storing a data directory of the data content.

2. The data storage apparatus as recited in claim 1, wherein the electronic tag is an active RFID tag.

3. The data storage apparatus as recited in claim 1, wherein the electronic tag further stores an ID label of the data storage apparatus.

4. A data storage system, comprising:
a host computer;
a data storage apparatus, connected to the host computer, and the data storage apparatus comprising:
a memory unit, connected to the host computer, for storing a data content;
an electronic tag, for accessing by the host computer, and storing a data directory of the data content; and
a controller, connected to the memory unit and the host computer, and the controller controlling the memory unit to access data according to a command of the host computer;
wherein, the host computer updates a data directory in the electronic tag according to an updated data content in the memory unit.

5. The data storage system as recited in claim 4, wherein the host computer updates or reads a data directory in the electronic tag by using a wireless transmission method.

6. The data storage system as recited in claim 5, wherein the electronic tag is an active RFID tag.

7. The data storage system as recited in claim 4, wherein the host computer updates or reads a data directory in the electronic tag by a data bus transmission method.

8. The data storage system as recited in claim 4, wherein the host computer further connects a reader, for reading a data directory in the electronic tag through the reader.

9. A directory accessing method, comprising the steps of:
providing a data storage apparatus having an electronic tag, and the electronic tag including a data directory of the data storage apparatus;
determining whether or not the data storage apparatus and a host computer establish a connection;
the host computer reading a data directory of the data storage apparatus, if the data storage apparatus and the host computers are connected;
determining whether or not the read data directory matches with the data of the data storage apparatus; and
writing an updated data directory into the electronic tag, if the read data directory does not match with the data of the data storage apparatus.

10. The directory accessing method as recited in claim 9, wherein the host computer needs to obtain an authorization of accessing the electronic tag, when the host computer is connected, and during the procedure of the host computer reading a data directory of the data storage apparatus.

11. The directory accessing method as recited in claim 9, wherein the host computer reads the data directory of the data storage apparatus, if the data storage apparatus is determined to be disconnected from a host computer, after the step of determining whether or not the data storage apparatus and the host computer establish a connection.

12. The directory accessing method as recited in claim 11, wherein the host computer needs to obtain an authorization of accessing the electronic tag, when the host computer is connected, and during the procedure of the host computer reading a data directory of the data storage apparatus.

13. The directory accessing method as recited in claim 9, wherein the host computer continues reading a data directory of the data storage apparatus, if the read data directory is determined to be matched with the data of the data storage apparatus after the step of determining whether or not the data directory matches with the data of the data storage apparatus.
